(19) United States
(12) Patent Application Publication
(10) Pub. No.: US 2018/0211219 A1
(43) Pub. Date: Jul. 26, 2018

(54) Transport Management System

(71) Applicant: Driving Innovations, LLC, Paradox, CO (US)

(72) Inventor: Timothy James Scott, Paradox, CO (US)

(73) Assignee: Driving Innovations, LLC, Paradox, CO (US)

(21) Appl. No.: 15/881,220

(22) Filed: Jan. 26, 2018

Related U.S. Application Data
(60) Provisional application No. 62/450,994, filed on Jan. 26, 2017.

(51) Int. Cl. G06Q 10/08; G06Q 10/04; G01C 21/34; G06Q 50/28

(52) U.S. Cl. CPC G06Q 10/08355; G06Q 50/28; G01C 21/3453; G06Q 10/047

(57) ABSTRACT

A computer implemented transport management system which generates vehicle load configurations based upon load indications including load weight, load dimensions, load origin and load destination and, which can estimate the cost of moving each vehicle load configuration over one or more routes between the load origin and the load destination.

This United States Non-Provisional Patent Application claims the benefit of U.S. Provisional Patent Application No. 62/450,994, filed Jan. 26, 2017, hereby incorporated by reference herein.

### I. FIELD OF INVENTION

A computer implemented transport management system which can generate vehicle load configurations based upon received load indications including one or more of load weight, load dimensions, load origin and load destination and, which can generate a cost estimate of moving each vehicle load configuration over one or more routes between the load origin and the load destination.

### II. SUMMARY OF THE INVENTION

Accordingly, a broad object of particular embodiments of the invention can be to provide a transport management system including a transport management computer program executable to receive load indications from one or more client computers, including one or more of a load weight, a load dimension, a load origin, and a load destination, and based on the load indications return one or more vehicle load configurations and one or more routes between the load origin and the load destination along with a cost estimate to move each vehicle load configuration over each route.

Another broad object of the invention can be to provide a server processor communicatively coupled to a server non-transitory computer readable media containing a computer program which includes one or more of: an interface module executable to depict a client user interface on a display surface of a client computer, a load query module operable to depict a load query menu in the client user interface which receives load query indications, an axle analyzer module executable to correlate the load query indications to one or more axle configurations, and a trailer configuration analyzer module operable to correlate the load query indications and axle configuration to return one or more trailer configurations.

Another broad object of the invention can be to provide a client processor communicatively coupled to a client non-transitory computer readable media containing a network browser capable of accessing a server over a network which serves a computer program executable to depict a user interface on a display surface of a client computer including a load query menu to receive load query indications including one or more of: a load weight, load dimensions, a load origin, and a load destination, which by execution of an axle analyzer module correlates the load weight or the load dimensions to one or more axle configurations, and by further operation of a trailer configuration analyzer module correlates the load query indications and the one or more axle configurations to one or more trailer configurations, and by further operation of a route analyzer module generates one or more routes between the load origin and the load destination, and by further operation of a vehicle load configuration analyzer returns one or more vehicle load configurations correspondingly movable over the one or more routes, and which receives a cost estimate based upon the fixed and variable costs associated with moving the one or more vehicle load configurations over the one or more routes between the load origin and the load destination.

Naturally, further objects of the invention are disclosed throughout other areas of the specification, drawings, photographs, and claims.

### III. A BRIEF DESCRIPTION OF THE DRAWINGS

FIG. 1 is block diagram of a particular embodiment of a transport management system.

FIG. 2 is an illustration of a particular embodiment of a client user interface.

FIG. 3 is an illustration of a particular embodiment of an administrator user interface.

FIG. 4 is an illustration of a particular embodiment of an equipment menu in the administrator user interface.

FIG. 5 is an illustration of a particular embodiment of a carrier menu in the administrator user interface.

FIG. 6 is an illustration of a particular embodiment of a shipper menu in the administrator user interface.

FIG. 7 is an illustration of a particular embodiment of a carrier equipment menu in the administrator user interface.

FIG. 8 is an illustration of a particular embodiment of a carrier equipment group menu in the administrator user interface.

FIG. 9 is an illustration of a particular embodiment of a jobs menu in the administrator user interface.

FIG. 10 is an illustration of a particular embodiment of a state criteria menu in the administrator user interface.

### IV. DETAILED DESCRIPTION OF THE PREFERRED EMBODIMENTS

Generally, a computer-implemented transport management system (1) (also referred to as the “system”) operable to compute a cost estimate (2) to transport a load over a route (3). Specifically, embodiments include a transport management program (4) (also referred to as the “computer program”) executable to analyze load indications (5), including one or more of: a load weight (6), load dimensions (7)(such as load height, load width, load length), a load origin (8), and a load destination (9), received over a network (10) to generate one or more of a vehicle load configuration (11), a route (3) between the load origin (8) and the load destination (9), and a cost estimate (2) of transporting the vehicle load configuration (11) over the route (3) between the load origin (8) and the load destination (9).

The System.

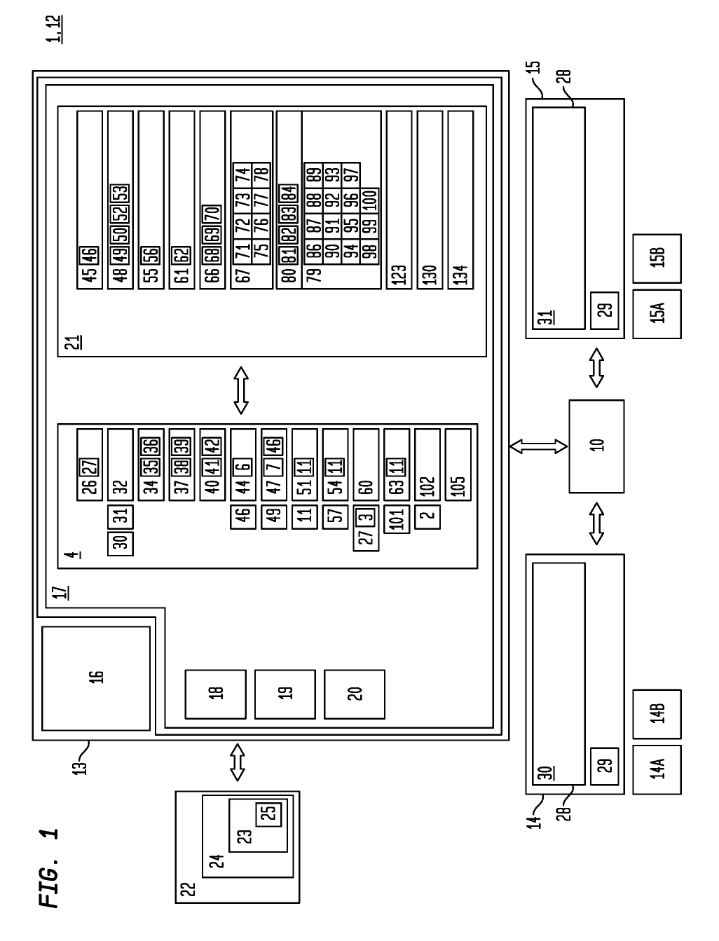

Referring generally to FIG. 1, embodiments of the computer implemented transport management system (1) can include a networked environment (12) including one or more server computers (13) (which can be located at one location or distributed at a plurality of locations) in data communication with a client computer (14), and in particular embodiments, in data communication with an administrator computer (15) via a network (10). The network (10) can, as illustrative examples, include: intranets, extranets, wide area networks such as the Internet, local area networks, wired networks, wireless networks, or other suitable networks, or any combination thereof. Each of the one or more servers (13) can include one or more of a server processor (16), a server memory (17), a server operating system (18), a server input/output interface (19), and a server network interface (20) operably coupled to one or more of the client computer (14) or the administrator computer (15) by the network (10).

Again, referring primarily to FIG. 1, the computer implemented transport management system (1) can further be communicatively coupled to one or more databases (21) maintained in one or more server memories (17). In particular embodiments, the system (1) can access a map server (22) including a map database (23). The map database (23) can be utilized in a web application (24) such as GOOGLE MAPS®, MAPQUEST®, PANORAMIO®, or the like, to retrieve map data (25) which can be analyzed by a route planner (26) to determine one or more routes (3) between a load origin (8) and a load destination (9). In particular embodiments, the route planner (26) can be further executed to display a geographic representation (27) of the map data (25) on the display surface (28) of a client computer (14) or an administrator computer (13) and display one or more routes (3) between a load origin (8) and a load destination (9).

Again, referring primarily to FIG. 1, one or more client computers (14) or one or more administrator computers (15) can be configured to connect with the one or more server computers (13) through the network (10) to transfer corresponding images and data. In particular embodiments, the one or more client computers (14) or the one or more administrator computers (15) can take the form of a limited-capability computer designed specifically for navigation on the World Wide Web of the Internet. Alternatively, the one or more client computers (14) or the one or more administrator computers (15) can take the form of full-capability computers, such as: desktop or laptop computers, hand-held devices such as smart phones, slate or pad computers, personal digital assistants or camera/cell phone, or multiprocessor systems, microprocessor-based or programmable consumer electronics, minicomputers, or the like, or combinations of limited-capability computers or full-capability computers.

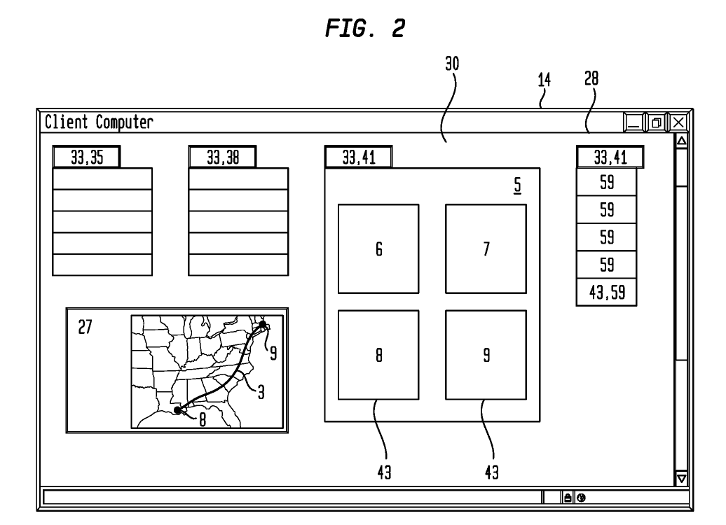

Again, referring primarily to FIG. 1, each of the one or more client computers (14) or administrator computers (15) can include a network browser (29) such as Microsoft's INTERNET EXPLORER®, GOOGLE CHROME®, MOZILLA FIREFOX®, or the like, which functions to download and render multimedia content that is formatted in “hypertext markup language” (HTML). In this environment, a server computer (13) can be programmed to implement the most significant portions of a client user interface (30) or an administrator user interface (31). As to these embodiments, the computer program (4) can be resident in the server computer (13) (as shown in the illustrative example of FIG. 1) and the one or more client computers (14) or the one or more administer computers (15) can use the network browser (29) to simply display downloaded content and to relay client user (14A) or administrator user (15A) inputs back to the server computer (13). The server computer (13) can respond by formatting new screen displays or menus (as shown in the illustrative examples of FIGS. 2 through 10) and downloading the screen displays or menus (33) for display on a display surface (28) of the one or more client or administer computers (14)(15).

In other embodiments, the one or more server computers (13) can be used primarily as sources of images and data, with primary responsibility for implementing the client or administrator user interface (30)(31) being placed upon each of the one or more client or administrator computers (14)(15). As to these embodiments, each of the one or more client or administrator computers (14)(15) can run the computer program (4) correspondingly implementing the client or administrator user interface (30)(31), to retrieve images and data from the server computer (13) or the map server (22) or the route planner (26). While illustrative examples in this description attribute a certain type of data to the server computer (13), for clarity, it is to be understood that various types of data may reside in one server computer (13) or one type of data can be distributed among a plurality of server computers (13) and embodiments of the invention can utilize server computers (13) to a lesser or greater extent depending upon the implementation of the computer program (4).

The client or administrator user (14A)(15A) can correspondingly enter corresponding user commands (14B)(15B) and information into one or more client computers (14) or one or more administrator computers (15) through input devices such as a keyboard or a pointing device such as a mouse; however, any method or device that converts client or administrator user action into commands and information can be utilized, including, but not limited to: a microphone, joystick, game pad, touch screen, or the like.

A “user command” occurs when the client or administrator user operates a computer program (4) function through use of a command, which, for example, can include pressing or releasing the left mouse button while a pointer is located over a control icon or other interactive field which activates a function of the computer program (4). However, it is not intended that a “user command” be limited to the press and release of the left button on a mouse while a pointer is located over a control icon (or field), rather, a “user command” is intended to broadly encompass a command by the client or administrator user through which the command activates a function of a computer program (4)(or other program, application, modules or the like), whether through selection of one or a plurality of control referents (such as one of a plurality of control referents in a drop down list), entry of values (such as load weight, load dimensions, load origin, or load destination) into fillable fields, or by user voice command, keyboard stroke, mouse button, touch on a touch screen, or otherwise.

While embodiments of the computer program (4) are described in the general context of computer-executable instructions such as program modules which utilize routines, programs, objects, components, data structures, or the like, to perform particular functions or tasks or implement particular abstract data types, it is not intended that any embodiments be limited to a particular set of computer-executable instructions or protocols.

### User Interface Module.

Now referring primarily to FIGS. 1 through 3, the computer program (4) in part includes a user interface module (32) executable to depict a client user interface (30) on a display surface (28) of a client computer (14), or an administrator user interface (31) on a display surface (28) of an administrator computer (15), which allows a client user (14A) of the client computer (14), or the administrator user (15A) of the administrator computer (15), to execute by user command (14B)(15B) one or more functions of the computer program (4). The client user (14A) interacts with one or more menus (33) depicted on the display surface (28) of the client computer (14) as part of the client user interface (30), or the administrator user interacts with one or more menus (33) depicted on the display surface (28) of the administrator computer (15) as part of the administrator user interface (31), to execute by user command one or more functions of the computer program (4).

### Sign Up Module.

Again, referring primarily to FIGS. 1 and 2, embodiments of the computer program (4) can, but need not necessarily, include a sign-up module (34) which upon execution depicts a sign-up menu (35) on the display surface (28) of the client computer (14), which by client user command (14B), allows the client user (14A) to create an account (36) under which the client user (14A) can authenticate the system (1) and access the functionalities of the computer program (4) through the client computer (14).

### Login Module.

Again, referring primarily to FIGS. 1 and 2, embodiments of the computer program (4) can, but need not necessarily, include a login module (37) which upon execution depicts a login menu (38) on the display surface (28) of the client computer (14), which by client user command (14B), allows the client user (14A) to log in to an account (36). To log in to an account (36), a client user (14A) can authenticate oneself with a password, or other credentials or recognition elements (such as fingerprint or facial recognition features) for the purposes of accounting, security, logging, and resource management. Once the client user (14A) has logged on, the system (1) will often use a user identifier (39) such as an integer to refer to the client user (14A), rather than their username, through a process known as identity correlation. As one illustrative example, in UNIX® systems, the username is correlated with a user identifier (39).

### Load Query Module.

Again, referring primarily to FIGS. 1 and 2, embodiments of the computer program (4) can include a load query module (40). The load query module (40) upon execution depicts a load query menu (41) on the display surface (28) of the client computer (14). The client user (14A) can input load indications (5) defining a load (42) into the load query menu (41).

For the purposes of this invention, the term “load (42)” means a shipment of goods, items, or objects transported by a vehicle between a load origin (8) and a load destination (9). While the illustrative example includes a load (42) transported by a truck (or tractor-trailer), this is not intended to obviate other vehicles such as planes, trains, automobiles, ships, boats or the like, or combinations thereof.

For the purposes of this invention, the term “load origin (8)” means the point or place where a route (3) begins. For the purposes of this invention, the term “load destination (9)” means the point or place where a route (3) ends.

For the purposes of this invention, the term “route (3)” means a way or course taken from the load origin (8) to the load destination (9).

For purposes of this invention, the term “load indications (5)” means physical characteristics of a load (42) or shipping parameters of a load (42). Physical characteristics can, as illustrative examples, include: load dimensions including one or more of load height, load length, load width, load weight, and can further include one or more of load fragility, live load, frozen load, liquid load, gas load, hazardous materials, or the like. Shipping parameters can include load origin (8) and load destination (9), and can further include rush delivery, carrier, multiple destinations, deck space, or the like.

In particular embodiments, as shown in the illustrative example of FIG. 2, the load query menu (41) can provide one or more fillable fields (43) in which the client user (14A) can enter load indications (5). The fillable fields (43) for entry of load indications (5), as shown in the example, include “load weight” (6), “load dimensions” (7), “load origin” (8), and “load destination (9).” For purposes of this invention, the term “load dimensions (7)” refers to one or more of measured length, height, or width of the load (42) to be transported in one shipment on a vehicle over a route (3). For the purposes of this invention “load weight (6)” means the measured static weight of one stationary object or the measured combined weights of all the objects to be transported in one shipment on a vehicle over a route (3).

The load query module (40) can be further executed to transmit the load indications (5) entered by the client user (14A) into the load query menu (41) from the client computer (14) to the server (13).

### Axle Analyzer Module.

Now referring primarily to FIG. 1, embodiments of the computer program can include an axle analyzer module (44). The axle analyzer module (44) can be communicatively coupled to an axle configuration database (45). The axle analyzer module (44) can be further executed to correlate the load weight (6) entered into the load query menu (41) against a plurality of axle configurations (46) contained in the axle configuration database (45). The axle analyzer module (44) can be further executed to return one or more axle configurations (46) which correlate to the load weight (6) entered into the load query menu (41).

### Trailer Configuration Analyzer Module.

Again, referring primarily to FIG. 1, embodiments of the computer program (4) can further include a trailer configuration analyzer module (47). The trailer configuration analyzer module (47) can be communicatively coupled to an equipment database (48). The equipment database (48) contains a plurality of trailer configurations (49). For the purposes of this invention, the term “trailer (50)” means one or more platforms or frames supported on one more axles, each axle having two or more wheels. As illustrative examples, an equipment database (48) can contain data on a numerous and wide variety of trailers (50) such as: double drop trailers, flatbed trailers, RGN/lowboy trailers, beam trailers, perimeter trailers, dolly trailers, step deck trailers, Schnabel trailers, blade trailers, shirly trailers, SPMT trailers, van trailers, conestoga trailers, curtainside trailers, belly dump trailers, gooseneck trailers, ball trailers, or the like. The trailer configuration analyzer module (47) can be further executed to correlate the one or more axle configurations (46) returned by the axle analyzer module (44) to a corresponding one or more trailer configurations (49) in the equipment database (48) having at least one of the axle configurations (46) returned by the axle analyzer module (44), and further compatible with the load dimensions (7) entered as load indications (5) into the load query menu (41). The trailer configuration analyzer module (47) can be further executed to return the one or more trailer configurations (49) which correlate to the axle configuration (46) and load weight (6).

### Vehicle Load Configuration Analyzer Module.

Again, referring primarily to FIG. 1, embodiments of the computer program (4) can include a vehicle load configuration analyzer module (51). The vehicle load configuration analyzer module (51) can be communicatively coupled to the equipment database (48). The vehicle load configuration analyzer module (50) can be executed to correlate the one or more trailer configurations with the load indications (5) (load weight (6) or load dimensions (7)) to return one or more vehicle load configurations (11) from the equipment database (48).

For purposes of this invention, “vehicle load configuration (11)” refers to a configuration including a tractor (52), a trailer (50), a load (42), and any ancillary vehicle attachments (53). The equipment database (48) can contain data related to a numerous and wide variety of tractors (52) which can be cross referenced by makes, models, and years. The equipment database (48) can store data related to vehicle attachments (53) including, without limitation, beams, boosters, stingers, flip axles, and other like vehicle attachments.

### Carrier Selection Module.

Again, referring primarily to FIG. 1, embodiments of the computer program (4) can include a carrier selection module (54). The carrier selection module (54) can be communicatively coupled to a carrier equipment database (55). The carrier equipment database (55) can be a separate database or a subdatabase within the equipment database (48). The carrier equipment database (55) can contain carrier equipment (56) associated with one or more carriers (57). The carrier selection module (54) can be executed to correlate the vehicle load configuration (11) returned by the vehicle load configuration analyzer module (51) to the carrier equipment (56) of one more carriers (57) contained in the carrier equipment database (55), and can be further executed to identify each carrier (57) having carrier equipment (56) correlated to the vehicle load configuration (11), and can be further executed to select one or more carriers (57) having carrier equipment (56) correlated with the vehicle load configuration (11) returned by the vehicle load configuration analyzer module (51) For the purposes of this invention, the term “carrier” means a company that undertakes the conveyance of the load (42).

In particular embodiments, the carrier selection module (54) can further depict in the carrier selector menu (58), operable by client user command (14A), a list of carriers (57) for a client user (14A) to select a carrier referent (59) (for example by drop down list), or depict a tillable field (43) wherein a client user (14A) can enter a carrier referent (59) to associate a carrier (57) in a carrier database (119) with a load (42).

### Route Analyzer Module.

Again, referring primarily to FIG. 1, embodiments of the computer program (4) can further include a route analyzer module (60) operable to receive load indications (5) pertaining to the load origin (8) and load destination (9) entered into the load query menu (41). The route analyzer module (60) can be further executed to generate one or more routes (3) between the load origin (8) and the load destination (9).

In generating the route (3), the route analyzer module (60) can call upon one or more route databases (61) which can, in part, include the map database (23), which can, but need not necessarily, be executed to display a geographic representation (27) of a geographic area on the display surface (28) of a client computer (14) or an administrator computer (15). The route analyzer module (60) can execute the route planner (26) to generate one or more routes (3) between the load origin (8) and the load destination (9). In particular embodiments, the map database (23) and the route planner (26) can be coordinated by the route analyzer module (60) to generate one or more routes (3) in the geographic representation (27) which can, but need not necessarily be, depicted on the display surface (28) of the client computer (14). The route database (61) can further include or associate roadway data (62) with the route (3), such as geometric measurements in three spatial directions (x, y and z) pertaining to roadway elements, functional classification (arterial, collector, and local), surface type, construction logs, road closures, vehicle load configuration limitations (such as weight limits, width limits, length limits, or height limits), bridges or overpass data axle configuration restrictions, hazardous material restrictions, and other like restrictions related to a vehicle load configuration (11).

### Cost Calculator Module.

Again, referring primarily to FIG. 1, embodiments of the computer program (4) can further include a cost calculator module (63). The cost calculator module (63) can be communicatively coupled to a cost database (64). The cost calculator module can correlate the vehicle load configuration (11) with cost data (65) including one or more of fixed costs (66) and variable costs (67) of transporting the load (42) over the route (3). The cost calculator module (63) can be executed to correlate the vehicle load configuration (11) with fixed costs (66) in the costs database (64) including one or more of: vehicle load configuration loan-lease payments (68), vehicle load configuration insurance payments (69), and vehicle load configuration permits (70). The cost calculator module (63) can be further executed to correlate the vehicle load configuration (11) with variable costs (67) in the cost database (64) including one or more of: a fuel cost (71), a tire cost (72), a maintenance cost (73), a lodging cost (74), a meal cost (75), a tax cost (76), a labor cost (77), and a profit margin cost (78). Further variable costs (67) contained in the cost database (64) can include a dunnage cost, a rigging cost, a materials cost, a custom fabrication cost, a detention cost, a layover cost, a hotel cost, a re-consignment cost, tolls, or the like.

In particular embodiments, the cost database (64) can further contain load regulating entity cost data (79) correspondingly associated with a plurality of load regulating entities (80). The load regulating entities (80) can be one or more of a federal load regulating entity (81), a state load regulating entity (82), county load regulating entity (83), or local load regulating entity (84). For purposes of this invention “load regulating entities (80)” are defined as entities capable of legislating or promulgating rules or regulations related to vehicular-based travel, transport, and shipping. Each of the plurality of load regulating entities (80) can be further correlated with related load regulating entity cost data (79). The load regulating entity cost data (79) can include, without limitation, load weight costs based on gross weight (85), load weight costs based on axle number (86), oversize load costs based on exceeding a load size threshold (87), overweight load costs based on exceeding a load weight threshold (88), overweight-oversized load costs based on exceeding both of said load size threshold and said load weight threshold (89). In further particular embodiments, the load regulating entity cost data (79) can further include route survey costs (90), front pilot vehicle costs (91), rear pilot vehicle costs (92), police escort costs (93), crane vehicle costs (94), and bucket vehicle costs (95). In yet further embodiments, the load regulating entity cost data (79) can include, without limitation vehicle load configuration fees (96) based on vehicle load configuration length (97), vehicle load configuration width (98), vehicle load configuration height (99), and vehicle load configuration overhang (100).

The cost calculator module (63) can evaluate and calculate each of the fixed costs (66), variable costs (67), and other costs, including costs associated with the plurality of load regulating entities (80), associated with moving the vehicle load configuration (11) from the load origin (8) to the load destination (9) based on the route (3) generated by the route analyzer module (60). The cost calculator module (63) can be further executed to return a summary of costs (101) containing all of the applicable costs to move the one or more vehicle load configurations (11) returned by the vehicle load configuration analyzer module (51) between the load origin (8) to the load destination (9) over the one or more routes (3) returned by the route analyzer module (60).

### Cost Estimate Module.

Again, referring primarily to FIG. 1, embodiments of the computer program (4) can further include a cost estimate module (102) operable to sum all costs returned in the summary of costs (101) generated by the cost calculator module (63). The cost estimate module (102) can further be executed to depict the summary of costs (101) generated by the cost calculator module (63) on the display surface (28) of the client computer (14) or on the display surface (28) of the administrator computer (15).

### Administrator Module.

Now referring to FIGS. 1 through 10, embodiments of the system (1) can, but need not necessarily, include an administrator module (105) executable to add, delete, or modify the data or values contained in one or more databases (21) associated with the computer program (4) including the axle configuration database (45), the equipment database (48), the carrier equipment database (55), the route database (61), and the cost database (64).

The user interface module (32) can be executed to depict an administrator user interface (31) on the display surface (28) of the administrator computer (15) including a plurality of administrator menus (108) which can be depicted on the display surface (28) of the administrator computer (15). Each administrator menu (108) can be communicatively coupled to one or more databases (21) containing data utilized by the computer program (4).

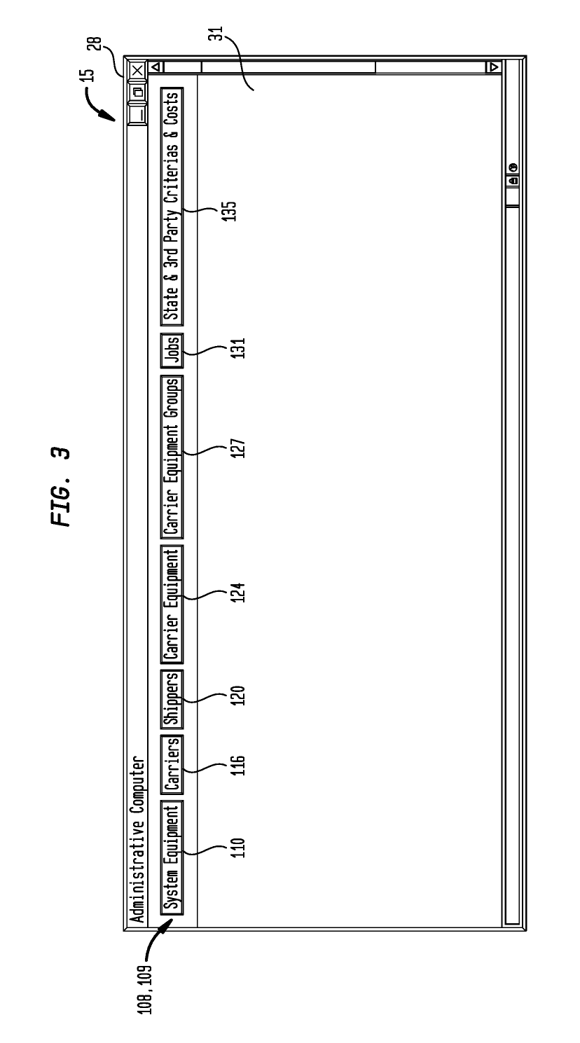

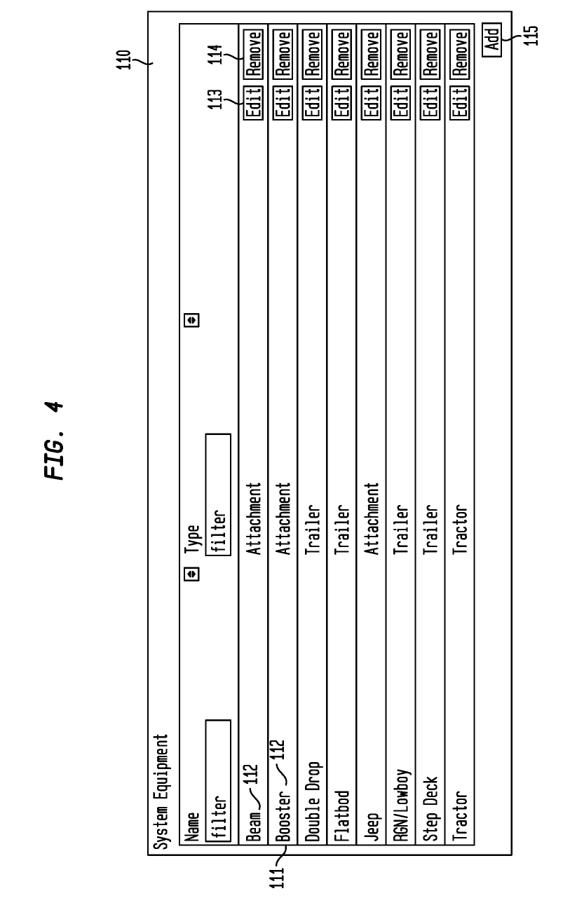

Now referring primarily to FIG. 3, in particular embodiments, the administrator graphical interface (107) can include selectable menu tabs (109) which upon selection depict the selected administrator menu (108)(as shown in the illustrative examples of FIGS. 4 through 10) on the display surface (28) of the administrator computer (15). An administrator can navigate through the administrator graphical interface (107) and execute the functionalities of the administrator module (105) by user commands (15B) in one or more of the administrator menus (108) to add, delete, or modify data contained in the corresponding database (21).

Now referring primarily to FIGS. 1, 3, and 4, the administrator user (15A) by selection of the menu tab (109) associated with the equipment menu (110) (depicted in the illustrative example of FIG. 3 as “System Equipment”) can cause depiction of the equipment menu (110) which depicts an equipment list (111) including a plurality of equipment referents (112) each associated with equipment data contained in the equipment database (48). Equipment referents (112) can be added, removed, or edited by user command, which in the illustrative example of FIG. 3 corresponds to selection of an edit button (113), a remove button (114), or an add button (115). The add button (115) permits an administrator user to input a new equipment referent (112), into the equipment list (111) for inclusion in the equipment database (48). The remove button (114) permits an administrator user to remove an equipment referent (112), from the equipment list (111), and consequently, deletion from the equipment database (48). The edit button (113) permits an administrator user (15A) to select a particular entry and alter the specifications and characteristics associated with that equipment referent (112) in the equipment database (48).

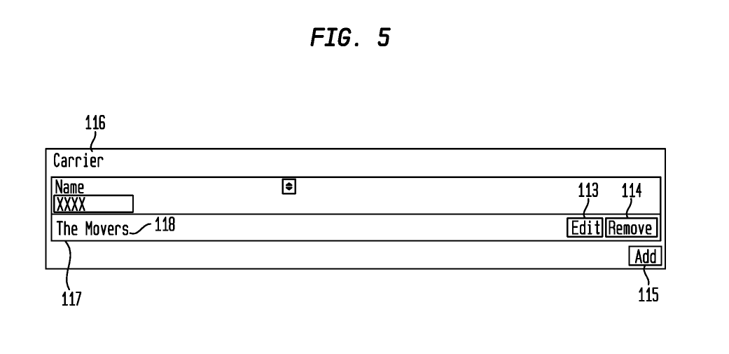

Now referring to FIGS. 1, 3, and 5, the administrator user (15A) by selection of the menu tab (109) associated with the carrier menu (116) (depicted in the illustrative example of FIG. 3 as “Carriers”) can cause depiction of the carrier menu (116) which depicts a carrier list (117) including a plurality of carrier referents (118) each associated with carrier data contained in the carrier database (119). Carrier referents (118) can be added, removed, or the specifications and characteristics associated with the carrier database (119) edited by user command, which in the illustrative example of FIG. 5 corresponds to selection of an edit button (113), a remove button (114) or an add button (115).

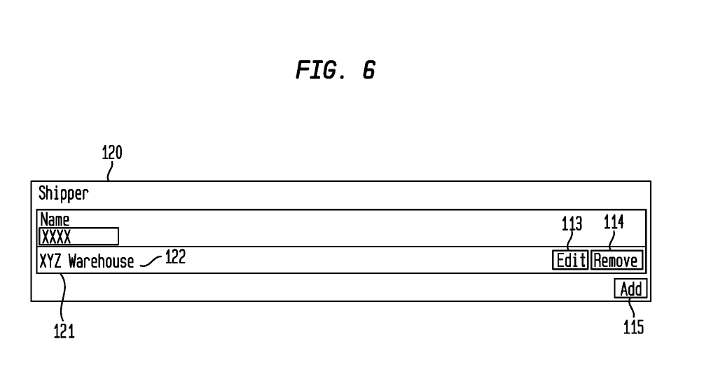

Now referring to FIGS. 1, 3, and 6, the administrator user (15A) by selection of the menu tab (109) associated with the shipper menu (120) (depicted in the illustrative example of FIG. 3 as “Shippers”) can cause depiction of the shipper menu (120) which depicts a shipper list (121) including a plurality of shipper referents (122) each associated with shipper data contained in the shipper database (123). Shipper referents (122) can be added, removed, or the specifications and characteristics associated with the shipper database (123) edited by administrator user command (15B), which in the illustrative example of FIG. 6 corresponds to selection of an edit button (113), a remove button (114) or an add button (115).

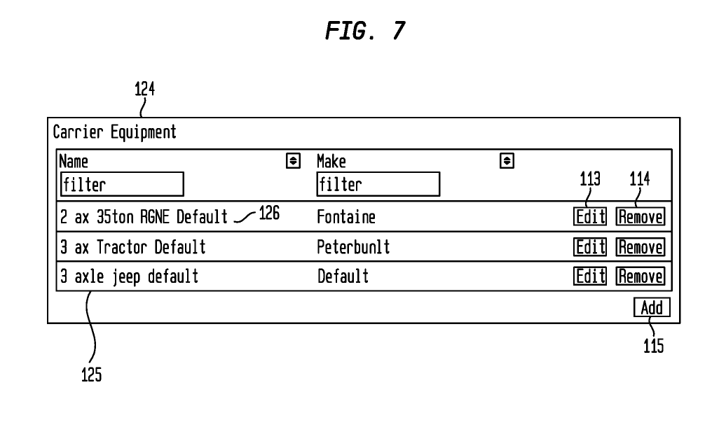

Now referring to FIGS. 1, 3, and 7, the administrator user (15A) by selection of the menu tab (109) associated with the carrier equipment menu (124) (depicted in the illustrative example of FIG. 3 as “Carrier Equipment”) can cause depiction of the carrier equipment menu (124) which depicts a carrier equipment list (125) including a plurality of carrier equipment referents (126) each associated with carrier equipment data contained in the carrier equipment database (55). Carrier equipment referents (126) can be added, removed, or the specifications and characteristics associated with the carrier equipment database (126) edited by administrator user command (15B), which in the illustrative example of FIG. 7 corresponds to selection of an edit button (113), a remove button (114) or an add button (115).

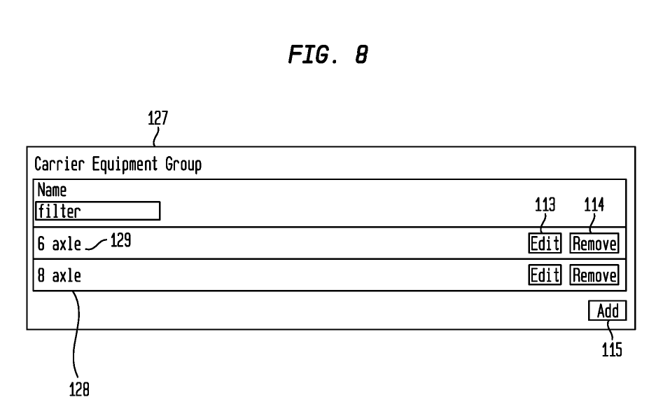

Now referring to FIGS. 1, 3, and 8, the administrator user (15A) by selection of the menu tab (109) associated with the carrier equipment group menu (127) (depicted in the illustrative example of FIG. 3 as “Carrier Equipment Group”) can cause depiction of the carrier equipment group menu (127) which depicts a carrier equipment group list (128) including a plurality of carrier equipment group referents (129) each associated with carrier equipment group data contained in the carrier equipment group database (130). Carrier equipment group referents (129) can be added, removed, or the specifications and characteristics associated with the carrier equipment group database (130) edited by user command, which in the illustrative example of FIG. 8 corresponds to selection of an edit button (113), a remove button (114) or an add button (115).

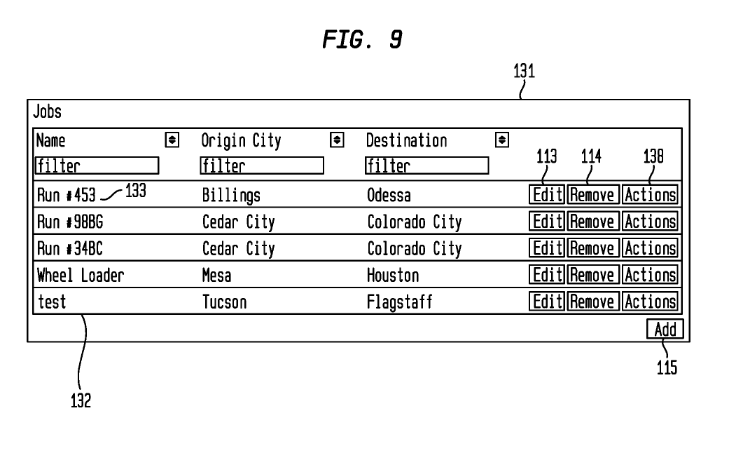

Now referring to FIGS. 1, 3, and 9, the administrator user (15A) by selection of the menu tab (109) associated with the jobs menu (131) (depicted in the illustrative example of FIG. 3 as “Jobs”) can cause depiction of the jobs menu (131) which depicts a jobs list (132) including a plurality of jobs referents (133) each associated with jobs data contained in the jobs database (134). Jobs referents (133) can be added, removed, or the specifications and characteristics associated with the jobs database (134) edited by administrator user command (15B), which in the illustrative example of FIG. 9 corresponds to selection of an edit button (113), a remove button (114) or an add button (115).

Now referring to FIG. 9, an additional “Actions” button (138) can be selected by the administrator user under the jobs menu (131). The selection of the actions button (138) for a specific jobs referent (133) causes the computer program (4) to be executed for that particular jobs referent (133) and operates to depict on the display surface (28) of the administrator computer (15) all or a portion of the calculations or returned results of the modules. For example selection of the actions button (138) can depict the vehicle load configuration (11) identified by the vehicle load configuration analyzer module (51) for that jobs referent (133), as well as the route (3) returned by the route analyzer module (60), and a breakdown of every cost returned by the cost calculator module (63). However, this example is not meant to limit various combinations of the calculations and returned results of the modules.

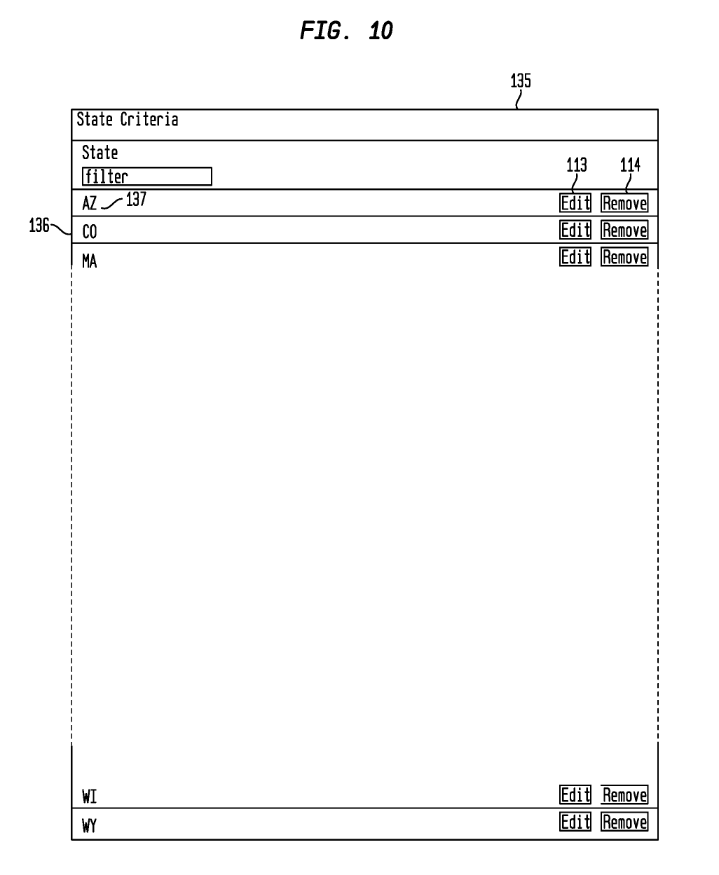

Now referring to FIGS. 1, 3, and 10, the administrator user by selection of the menu tab (109) associated with the load regulating entity costs menu (135) (depicted in the illustrative example of FIG. 3 as “State & 3^{rd} Party Criteria & Costs”) can cause depiction of the costs menu (135) which depicts a costs list (136) including a plurality of costs referents (137) each associated with costs data contained in the costs database (64). Costs referents (137) can be added, removed, or the specifications and characteristics associated with the costs database (64) edited by user command, which in the illustrative example of FIG. 10 corresponds to selection of an edit button (113), a remove button (114) or an add button (115).

As can be easily understood from the foregoing, the basic concepts of the present invention may be embodied in a variety of ways. The invention involves numerous and varied embodiments of a vehicular shipping system and methods of use thereof. As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of “transport management” should be understood to encompass disclosure of the act of “transport managing”—whether explicitly discussed or not—and, conversely, were there the disclosure of the act of “transport managing”, such a disclosure should be understood to encompass disclosure of a “transport management” and even a “means for transport management.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

Thus, the applicant(s) should be understood to claim at least: i) each of the vehicular shipping systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

Any claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of any such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Any claims set forth below are intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any United States non-provision patent application or Patent Cooperation Treaty patent application, or any continuation, division, or continuation-in-part, or similar application thereof.

1-23. (canceled)

24. A computer system, comprising:
a server including a server processor communicatively coupled to a non-transitory computer readable media including a computer code, said server accessible by a client computer through a public network, said computer code including:
an interface module operable to depict a user interface on a display surface of said client computer;
a load query module operable to depict a load query page of said user interface and to receive load data indications in said load query page, said load data indications including a load weight and load dimensions of a load;
an axle analyzer module operable to correlate said load data indications received into said load query page against an axle configuration database to return one or more axle configurations associated with said load;
a trailer configuration analyzer module operable to correlate said load weight, said load dimensions, and said axle configurations returned by said axle analyzer module with trailer configuration data in an equipment database to return one or more trailer configurations compatible with said load.

25. The computer system of claim 24, wherein said computer code further comprising a vehicle load configuration analyzer operable to correlate said trailer configurations and said load with one or more vehicle load configurations and return a vehicle load configuration to carry said load.

26. The computer system of claim 25, wherein said load query module further operable to depict said load query page to receive load route indications including a load origin and a load destination, further comprising:
a route analyzer module operable to correlate said vehicle load configuration with one or more routes between said load origin and said load destination;
generate a route from said load origin to said load destination based on said vehicle load configuration; and
return said route to said client computer.

27. The computer system of claim 26, further comprising a cost calculator module which correlates said vehicle load configuration moving said load over said route with cost data in a cost database and returns a summary of costs associated with moving said vehicle load configuration over said route.

28. The computer system of claim 27, wherein said cost calculator module further executable to correlate said cost data with a plurality of load regulating entities based on said vehicle load configuration and said route.

29. The computer system of claim 28, wherein said load regulating entities include one or more of federal, state, county or local entities associated with said route.

30. The computer system of claim 29, wherein said cost calculator further executable to correlate each of said load regulating entities with load regulating entity cost data in said cost database associated with moving said vehicle load configuration over said route.

31-33. (canceled)

34. The computer system of claim 27, wherein said cost calculator further executable to correlate fixed cost data in said cost database with said vehicle load configuration and said route.

35. The computer system of claim 34, wherein said fixed costs associated with said vehicle load configuration including one or more of: vehicle load configuration loan-lease payments, vehicle load configuration insurance payments, and vehicle load configuration permits.

36. The computer system of claim 27, wherein said cost calculator further executable to correlate variable cost data in said cost database with said vehicle load configuration and said route.

37. The computer system of claim 36, wherein said variable cost data associated with said vehicle load configuration and said route include one or more of: a fuel cost, a tire cost, a maintenance cost, a lodging cost, meal cost, a tax cost, a labor costs, a profit margin cost, a dunnage cost, a rigging cost, a materials cost, a custom fabrication cost, a detention cost, a layover cost, a hotel cost, a re-consignment cost, and tolls.

38. The computer system of claim 25, wherein said vehicle load configuration analyzer further executable to correlate said vehicle load configuration returned from said vehicle configuration database to equipment contained in an equipment database; and
identify said equipment contained in said equipment database associated with said vehicle load configuration.

39. The computer system of claim 25, wherein said computer code further comprising:
a carrier selection module operable to correlate said vehicle load configuration to a carrier equipment database containing equipment associated with each of a plurality of carriers;
identify each carrier having said equipment to generate said vehicle load configuration; and
select a carrier to carry said load over said route.

40. The computer system of claim 38, wherein said equipment database retrievably stores trailer data including one or more of: double drop trailers, flatbed trailers, RGN/lowboy trailers, beam trailers, perimeter trailers, dolly trailers, step deck trailers, Schnabel trailers, blade trailers, shirly trailers, SPMT trailers, van trailers, conestoga trailers, curtainside trailers, belly dump trailers, gooseneck trailers, and ball trailers.

41. The computer system of claim 40, wherein said equipment database retrievably stores tractor data.

42. The computer system of claim 41, wherein said equipment database retrievably stores vehicle attachment data.

43. The computer system of claim 27, wherein said cost data base retrievably stores fixed cost data associated with said equipment contained in said equipment database, including equipment maintenance cost data, equipment insurance cost data, equipment loan cost data, and equipment lease cost data, or combination thereof.

44. The computer system of claim 43, wherein said cost database retrievably stores variable cost data associated with said equipment contained in said equipment database, including: equipment fuel cost data and equipment labor cost data.

45. The computer system of claim 44, wherein said cost database retrievably stores service cost data associated with one or more services including police escort cost data, pilot vehicle escort cost data, route survey cost data, crane service cost data, rigging service cost data, or combination thereof.

46. The computer system of claim 27, wherein said computer code further comprising a cost estimate module operable to sum all costs based on said cost data retrieved from said cost database associated with said vehicle load configuration over said route.

47-134. (canceled)
